(19) United States
(12) Patent Application Publication
(10) Pub. No.: US 2011/0210519 A1
(43) Pub. Date: Sep. 1, 2011

(54) FERROFLUID SEALING APPARATUS WITH SMALL DIAMETER USED IN LOW TEMPERATURE

(75) Inventors: Decai Li, Beijing (CN); Wenming Yang, Beijing (CN)

(73) Assignee: Beijing Jiaotong University

(21) Appl. No.: 13/033,635

(22) Filed: Feb. 24, 2011

(30) Foreign Application Priority Data
Mar. 1, 2010 (CN) 201010115789.7

(51) Int. Cl. F16J 15/43

(52) U.S. Cl. 277/410

(57) ABSTRACT

A ferrofluid sealing apparatus with small diameter used in low temperature, in which the first bearing (6), the first magnetism isolating ring (9), the first pole piece (10) installed with the first O-ring (11), the magnet (13), the second pole piece (15) installed with the second O-ring (14), the second magnetism isolating ring (16) and the second bearing (17) are provided to abut against in series and are sandwiched between the two inner bosses of the outer casing (8). the large end cover (19) is installed on the outer casing (8) using screw 18 to press the second bearing (17), the ferrolluid (2) is injected into the inner torus of the magnet (13), the permeable casing (1) installed with the adjusting shim (20) is installed into the inner hole of the above assembled bearings and pole pieces, the permeable casing (1) is fixed with the small end cover (5) using screw (4), the parameters of the teeth on the outside of the permeable casing are selected in such a way that the width is 0.5 mm, the height is 2.5 mm, and the width of the grooves is 1.5 mm, the first magnetism isolating ring (9) is installed between the first bearing (6) and the first pole piece (10); the second magnetism isolating ring (16) is installed between the second bearing (17) and the second pole piece (15). This apparatus solve the problem of ferrofluid sealling in low temperature.

### FIELD OF THE PRESENT INVENTION

The invention belongs to sealing technology in mechanical engineering, especially to be used as a vacuum sealing or a pressure sealing where the temperature is below −40° C. and the sealing diameter is smaller than 40 mm in military, ship, and aerospace industries.

### BACKGROUND OF THE PRESENT INVENTION

The ferrofluid seal of which the shaft diameter is 5 to 40 mm has many actual applications, in which the working temperature is very often at 0 to 20° C. But long term operation below −40° C. is required in some special areas. Sharp change of the viscosity of the ferrofluid will occur because of such a low temperature. And the space available for any magnetic circuit is very small because of the small diameter of the shaft. Moreover, with the permeability of the bearings around the sealing structure, it is very difficult to design the magnetic circuit itself. These problems need to be solved urgently in specific areas.

### SUMMARY OF THE PRESENT INVENTION

The invention is to provide a ferrofluid sealing apparatus with small diameter used in low temperature, which is used to solve the problem of bad applicability of present method and structure of ferrofluid seals.

Thus, according to the present invention, there is provided a ferrofluid sealing apparatus with small diameter used in low temperature, which comprises: a small end cover, a permeable casing, an outer casing, O-rings, bearings, an adjusting shim, pole pieces, ferrofluid, a magnet, and a large end cover.

The first bearing, the first pole piece installed with the first O-ring, the magnet, the second pole piece installed with the second O-ring and the second bearing are provided to abut against in series and are sandwiched between the two inner bosses of the outer casing. The large end cover is installed on the outer casing using screws to press the second bearing. The ferrofluid is injected into the inner torus of the magnet. The permeable casing installed with the adjusting shim is installed into the inner hole of the above assembled bearings and pole pieces. The permeable casing is fixed with the small end cover using screws.

There is an air gap with a definite width between pole pieces and the bearings by the magnetism isolating rings, which avoid the influence on the magnetic circuit by the bearings, such that the ferrofluid is absorbed in the sealing gap by the appropriate magnetic field.

Two groups of teeth 3 are provided on the outer cylindrical surface of the permeable casing 1. The parameters of the teeth are selected in such a way that the width is 0.5 mm, the height is 2.5 mm, and the width of the grooves is 1.5 mm.

The beneficial effect of this invention is that the magnetic circuit is optimized because of the optimal parameters of the teeth. The influence on the magnetic circuit by the bearings is avoided by the magnetism isolating rings. The ferrofluid used here is made of quality kerosene, silicate ester, or diester. The diameter of the magnetic particles in the ferrofluid 2 is smaller than 5 nm. The ferrofluid seal is used in small diameter and temperature lower than −40° C. Such that the leakage rate is lower than 10⁻¹¹ pal·m³/s and the life is very long. Besides, the assembly method is easy and the sealing problems are solved.

### BRIEF DESCRIPTION OF THE ACCOMPANYING DRAWINGS

FIG. 1 shows the ferrofluid sealing apparatus with small diameter used in low temperature.

FIG. 2 shows the profile of the permeable casing of the ferrofluid sealing apparatus with small diameter used in low temperature.

FIG. 3 shows the enlarged view of the teeth A and B on the permeable casing.

FIG. 4 shows the profile of the first and the second pole piece.

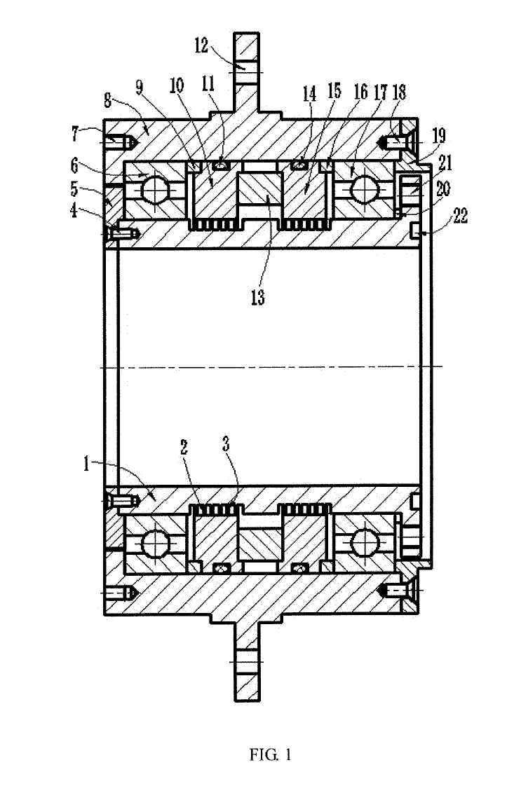

In the figures, there are shown a permeable casing 1, ferrofluid 2, sealing teeth 3, a screw 4, a small end cover 5, a first bearing 6, threaded holes 7, an outer casing 8, the first magnetism isolating ring 9, the first pole piece 10, the first O-ring 11, a via hole 12, a magnet 13, the second O-ring 14, the second pole piece 15, the second magnetism isolating ring 16, the second bearing 17, a screw 18, a large end cover 19, an adjusting shim 20, a threaded hole 21, and a sealing groove 22.

### PREFERRED EMBODIMENTS TO CARRY OUT THE PRESENT INVENTION

A further explanation of embodiments of this invention is made with the attached drawings.

A ferrofluid sealing apparatus with small diameter used in low temperature comprises: a small end cover 5, a permeable casing 1, an outer casing 8, the first bearing 6, the first magnetism isolating ring 9, the first pole piece 10, the first O-ring 11, the second O-ring 14, the second pole piece 15, the second magnetism isolating ring 16, the second bearing 17, ferrofluid 2, a magnet 13, and a large end cover 19.

The first bearing 6, the first magnetism isolating ring 9, the first pole piece 10 installed with the first O-ring 11, the magnet 13, the second pole piece 15 installed with the second O-ring 14, the second magnetism isolating ring 16, and the second bearing 17 abut upon the inner boss of the outer casing 8 in turn. The large end cover 19 is installed on the outer casing 8 using screws 18 so as to press the second bearing 17. The ferrofluid 2 is injected into the inner torus of the magnet 13. The permeable casing 1 installed with the adjusting shim 20 is installed into the inner hole of the above assembled bearings and pole pieces. The permeable casing 1 is fixed with the small end cover 5 using screws 4.

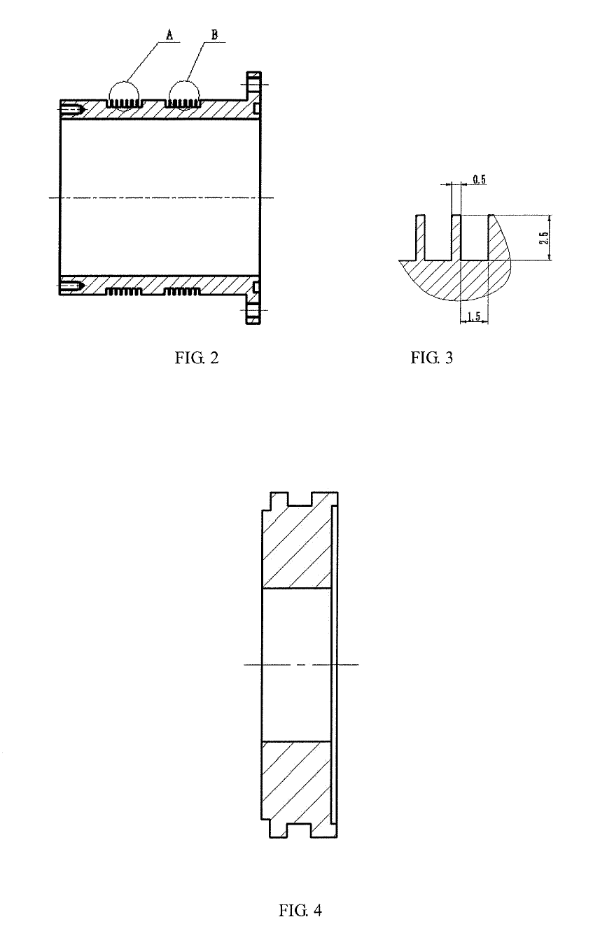

Two groups of teeth 3 are designed on the outer cylindrical surface of the permeable casing 1. As the parameters of the teeth, the width is 0.5 mm, the height is 2.5 mm, and the width of the grooves is 1.5 mm, as shown in FIGS. 2 and 3.

The first magnetism isolating ring 9 is installed between the first bearing 6 and the first pole piece 10. The second magnetism isolating ring 16 is installed between the second bearing 17 and the second pole piece 15. The first and the second bearings are of the same type as each other. The outer diameter of the first magnetism isolating ring 9 and the second magnetism isolating ring 16 is the same as that of the first and the second bearings (6, 16).

The ferrofluid 2 injected into the structure is absorbed in the gap between the two groups of sealing teeth 3 and the first and the second pole pieces (10, 15), which forms a reliable seal.

The based fluid of the ferrofluid 2 used in this structure is quality kerosene, silicate ester, or diester. They have good fluidity in the temperature as low as −40° C. The diameter of the magnetic particles in the ferrofluid 2 is smaller than 5 nm, which is appropriate when using in lower temperature.

The adjusting shim 20 is used to adjust the axial distance when assembling.

The magnetism isolating rings are used to separate the bearings and pole pieces in some distance, between which the air gap is to increase the magnetic reluctance of the magnetic circuit, which can avoid the decrease of the magnetic field intensity in the sealing gap.

The first pole piece 10 and the second pole piece 15 have the same structure as each other, as shown in FIG. 4. The grooves on the outer cylinder surface of the pole pieces are used to install the first and the second O-rings. A counterbore is designed on one end face of the pole pieces, which is used to install the magnet. A boss is designed on the other end face of the pole pieces, which is used to install the magnetism isolating rings. The first and the second pole pieces 10, 15 is made of an electrical pure iron.

In order to realize sealing with diameter smaller than 40 mm and used in the temperature below −40° C., the parameters of the teeth are selected in such a way that the width is 0.5 mm, the height is 2.5 mm, and the width of the grooves is 1.5 mm, as shown in FIG. 3. The structures of A and B are the same as each other, as shown in FIGS. 2 and 3. The gap between the pole pieces and the sealing teeth 3 on the permeable casing 1 is 0.1 mm. The pressure capability of each stage can reach to 0.5 atm. Preferably, the based fluid of the ferrofluid is quality kerosene, silicate ester, or diester, while the diameter of the magnetic particles in the ferrofluid 2 is smaller than 5 nm, so as to keep good fluidity in the temperature lower than −40° C., thus realizing a reliable sealing.

The screw threaded holes 7, the via hole 12, and the threaded hole 21 are designed in order to connect with other devices.

The sealing groove 22 is designed in order to use this apparatus.

The outer casing 8, adjusting shim 20, the large end cover 19, screws 4, and screws 18 are made of non-magnetic materials, like stainless steel.

The permeable casing is made of magnetic material like 45 steel.

The material of the magnetism isolating ring is duralumin.

The material of the permanent magnet is Nd—Fe—B.

### Example

A vacuum sealing was designed for a rotating shaft with diameter 20 mm, which had 12 stages for pole pieces. The gap between the teeth of the pole pieces and the permeable casing was 0.1 mm, whose width was 0.5 mm, height was 2.5 mm, and the width of the grooves was 1.5 mm. The ferrofluid used here was Fe₃O₄ colloid based on quality kerosene and the diameter of the Fe₃O₄ particles was 4 nm. The material of the permanent magnet was Nd—Fe—B. The leakage rate of this device was lower than 10⁻¹¹ pal·m³/s and there was no magnetic leakage.

This sealing apparatus can also be used in a positive pressure seal whose temperature is lower than −40° C. and the sealing shaft is smaller than 40 mm.

1. A ferrofluid sealing apparatus with small diameter used in low temperature, which comprises: a small end cover, a permeable casing, an outer casing, O-rings, bearings, adjusting shims, pole pieces, ferrofluid, a magnet, and a large end cover in which the first bearing (6), the first pole piece (10) installed with the first O-ring (11), the magnet (13), the second pole piece (15) installed with the second 0-ring (14), and the second bearing 17 are provided to abut against in series and are sandwiched between the two inner bosses of the outer casing (8); the large end cover (19) is installed on the outer casing (8) by means of screws so as to press the second bearing (17); the ferrofluid is injected into the inner torus of the magnet; the permeable casing (1) installed with the adjusting shim (20) is installed into the inner hole of the above assembled bearings and pole pieces; and the permeable casing (1) is fixed with the small end cover (5) using screws (4),
characterized in that two groups of teeth (3) are provided on the outer cylindrical surface of the permeable casing (1); the parameters of the teeth are determined in such a way that the width is 0.5 mm, the height is 2.5 mm, and the width of the grooves is 1.5 mm; and
the first magnetism isolating ring (9) is installed between the first bearing (6) and the first pole piece (10), while the second magnetism isolating ring (16) is installed between the second bearing (17) and the second pole piece (15).

2. A ferrofluid sealing apparatus with small diameter used in low temperature as claimed in claim 1, wherein the based fluid of the ferrofluid (2) is quality kerosene, silicate ester, or diester; and the diameter of the magnetic particles in the ferrofluid (2) is smaller than 5 nm.
